(19) United States
(12) Patent Application Publication
(10) Pub. No.: US 2004/0157542 A1
(43) Pub. Date: Aug. 12, 2004

(54) Bone/ribcage spreader device for big game animals, livestock, and the like

(76) Inventor: David R. Bloch, Niwot, CO (US)

Correspondence Address: Emery L. Tracy, P.O. Box 1518, Boulder, CO, 80306-1518, US

(21) Appl. No.: 10/757,649

(22) Filed: Jan. 14, 2004

Related U.S. Application Data
(60) Provisional application No. 60/440,132, filed on Jan. 15, 2003.

(51) Int. Cl. A22B 5/10

(52) U.S. Cl. 452/102

(57) ABSTRACT

A bone/ribcage spreader device for spreading the bones/ribcage of a game animal is provided. The bone/ribcage spreader device comprises a first arm and a second arm each having a first end and a second end with the second ends having a first protrusion and a second protrusion surrounding a recessed area. The first arm has a straight portion and an angled portion. A stop mechanism is formed on the second arm with the stop mechanism contactable with the first arm. A pivot point at the first end of the first arm and the first end of the second arm rotatably connects the first arm to the second arm wherein the bones/ribcage to be spread are positioned within the recessed portion of the first arm and the second arm such that upon rotation of the first arm and the second arm relative to each other until the stop mechanism contacts the first arm, the first arm and the second arm automatically releasably lock thereby maintaining the bone/ribcage within each recessed portion and spreading the bones/ribcage open.

The present application is a continuation and claims priority of pending provisional patent application Serial No. 60/440,132, filed on Jan. 15, 2003, entitled “Bone/ribcage spreader Device”.

### BACKGROUND OF THE INVENTION

1. Field of the Invention

This invention relates generally to a bone/ribcage spreader device for big game animals, and domestic livestock and the like and, more particularly, the invention relates to a bone/ribcage spreader device for field dressing out big game carcass and for holding the ribs of the carcass apart while cleaning out the internal organs and later hanging the carcass for cooling.

2. Description of the Prior Art

After a game animal has been taken in the field, and life functions have ceased, the first task is to field dress the animal. Field dressing involves removing all internal organs (viscera) from the upper and lower body cavity. The internal organs of the game animal must be removed quickly to prevent the meat from spoiling and for more rapid cooling and drying of the carcass and meat.

Dressing the game animal is frequently difficult, however, because the ribs of the animal typically curve inward encircling the viscera of the upper body cavity and leaving only a very small opening from which to remove these innards including the diaphragm, heart, lungs, trachea, and esophagus. To create a larger opening for removing viscera from the upper body cavity, frequently a hunter or butcher will saw through the center of the ribcage from the brisket up to the neck and spread the ribcage apart. Spreading the ribcage apart is difficult to do without an extra set of hands. Hunters in the field often find themselves in a very messy and difficult procedure if they do not have the aid of companions to assist them. Once the body has been emptied of all viscera, it is desirable to have the ribcage spread open to enable increased airflow inside the body cavity for more rapid cooling and drying of the meat prior to butchering.

It is necessary to hold the game animal carcass apart stabilizing the carcass to keep it from rolling and holding the rib cage apart in order to remove the internal organs from the upper and lower body cavity. The field dresser is then allowed to see what is needed to be done and eliminates the need for the field dresser to reach up into the rib cage blindly thus eliminating excessive blood on the field dresser's arms and clothing. Spreading the ribcage also improves safety to the field dresser since one can easily be cut when cutting blindly inside the cramped upper body cavity. While cleanliness is of considerable value to the field dresser, the risk of contracting Lyme disease is also minimized.

Devices for spreading the rib cage of a game animal and livestock are known in the art. Archaic methods, such as the use of wooden sticks found in the near by brush, etc., have been used ineffectively. Also, using two people with each holding a leg is also quite ineffective and cumbersome. Oftentimes, hunters are by themselves when they are hunting and would not have another person to assist in the field dressing process.

Unfortunately, suitable mechanisms have not been previously developed for oppositely engaging each of the two sides of an animal's rib cage with non-slip members that remain engaged at the points of engagement until specifically removed therefrom. In addition, previously known rib spreading devices require complicated manipulation for operation. It is not always convenient for a hunter or butcher to dedicate his or her self to complicated manipulation during the rib spreading operation because associated manipulation is often required of either other devices or particular parts of the animal to ensure proper engagement and operation of the device during the rib spreading process.

Finally, during many hunting outings, hunters have a tremendous amount of gear and other supplies to carry over potentially long distances. Conventional rib cage spreading devices are quite cumbersome, heavy, complicated, and expensive to manufacture. Together with the other gear, these devices are, for the most part left behind or too costly for the hunter to purchase thereby leaving these devices mostly ineffective.

Accordingly, there exists a need for a bone/ribcage spreader device for game animals, livestock and the like which allows a hunter to field dress a game animal with minimal untidiness and disorder. Additionally, a need exists for a bone/ribcage spreader device for game animals and the like which is easy for one person to operate and effectively spreads the ribs for access to the inside of the game animal. Furthermore, there exists a need for a bone/ribcage spreader device for game animals and livestock which is simple and inexpensive to manufacture, lightweight and easily carried by the hunter with other gear. These enhancements and benefits are described in greater detail herein below with respect to several alternative embodiments of the present invention.

### SUMMARY

The present invention is a bone/ribcage spreader device for spreading the bones/ribcage of a game animal. The bone/ribcage spreader device comprises a first arm and a second arm each having a first end and a second end with the second ends having a first protrusion and a second protrusion surrounding a recessed area. The first arm has a straight portion and an angled portion. A stop mechanism is formed on the second arm with the stop mechanism contactable with the first arm. A pivot point at the first end of the first arm and the first end of the second arm rotatably connects the first arm to the second arm wherein the bones/ribcage to be spread are positioned within the recessed portion of the first arm and the second arm such that upon rotation of the first arm and the second arm relative to each other until the stop mechanism contacts the first arm, the first arm and the second arm automatically releasably lock thereby maintaining the bone/ribcage within each recessed portion and spreading the bones/ribcage open.

In addition, the present invention includes a mechanism for spreading the bones of a game animal and livestock. The mechanism comprises a first bone contacting means for contacting a first bone and a second bone contacting means for contacting a second bone. The first bone contacting means is pivotally connected to the second bone contacting means. Alignment means aligns the line of force between the first bone and the second bone over the pivot point between the first bone contacting means and the second bone contacting means.

The present invention further includes a method for spreading the bones of a game animal and livestock. The method comprises providing a first member, providing a second member, pivotally connecting the first member to the second member, contacting a first bone with the first member, contacting a second bone with the second member, pivoting the first member in a general direction away from the second member, and aligning the line of force between the first bone and the second bone over the pivot point between the first member and the second member.

### BRIEF DESCRIPTION OF THE DRAWINGS

FIG. 1 is an elevational side view illustrating a bone/ribcage spreader device for big game animals, livestock, and the like, constructed in accordance with the present invention, with the bone/ribcage spreader device in a retracted position;

FIG. 2 is an elevational side view illustrating the bone/ribcage spreader device for big game animals, livestock, and the like of FIG. 1, constructed in accordance with the present invention, with the bone/ribcage spreader device in an extended position;

FIG. 3 is an elevational side view illustrating the bone/ribcage spreader device for big game animals, livestock, and the like of FIG. 1, constructed in accordance with the present invention, with the bone/ribcage spreader device in a retracted position within the ribcage of an animal; and

FIG. 4 is an elevational side view illustrating the bone/ribcage spreader device for big game animals, livestock, and the like of FIG. 1, constructed in accordance with the present invention, with the bone/ribcage spreader device in an extended position within the ribcage of an animal.

### DETAILED DESCRIPTION OF THE PREFERRED EMBODIMENTS

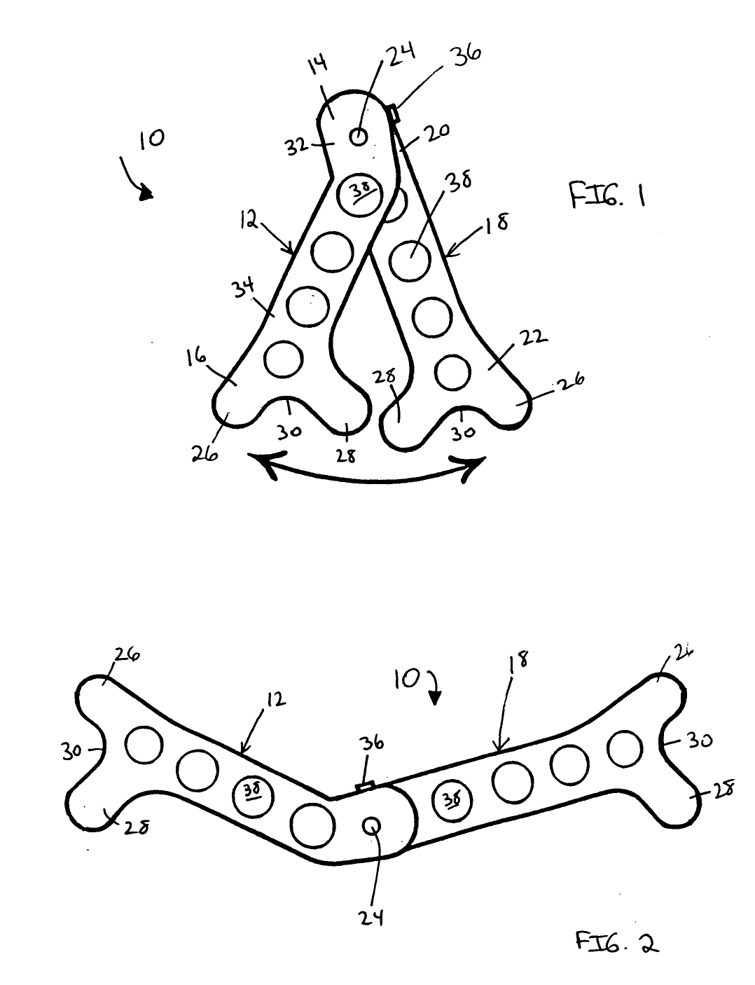

As illustrated in FIGS. 1 and 2, the present invention is a bone/ribcage spreader device, indicated generally at 10, for spreading the bones, in particular, the rib cage 11, of a game animal (not shown) such as deer, elk, antelope, pigs, cattle etc., thereby allowing a hunter, butcher, or other person to more easily field dress and clean the animal.

The bone/ribcage spreader device 10 of the present invention includes a first arm 12 having a first end 14 and a second end 16 and a second arm 18 having a first end 20 and a second end 22. The first end 14 of the first arm 12 and the first end 20 of the second arm 18 are rotatably connected about a pivot point 24.

The second end 16 of the first arm 12 and the second end 22 of the second arm 18 each have a first protrusion 26 and a second protrusion 28 surrounding a recessed portion 30. When using the bone/ribcage spreader device 10 of the present invention, the bones to be spread are positioned within the recessed portion 30 of the first arm 12 and the second arm 18 with the first protrusion 26 and the second protrusion 28 assisting in maintaining the bone within recessed portion 30.

The first arm 12 includes a straight portion 32 adjacent the first end 14 and an angled portion 34. Angling the first arm 12 in such manner as described allows the line of force between the second ends 16, 22 of the first arm 12 and the second arm 18, when spreading the bones/ribcage, to be positioned generally over the pivot point 24, as illustrated in FIG. 2. This allows the bone/ribcage spreader device 10 to releasably lock into position thereby maintaining the bone/ribcage spread of the animal.

The bone/ribcage spreader device 10 of the present invention further includes a stop mechanism 36 formed on the second arm 18 positioned adjacent the first end 20 of the second arm 18 substantially between the pivot point 24 and the first end 20. The stop mechanism 36 inhibits the rotation of the first arm 12 relative to the second arm 18 when the straight portion 32 of the first arm 12 is substantially aligned with the second arm 18.

It is preferable that the stop mechanism 36 is positioned between the first end 20 of the second arm 18 and the pivot point 24 nearingly adjacent the pivot point 24 to inhibit the pinching of the user by the stop mechanism 36 during use of the bone/ribcage spreader device 10. Also, it is preferable that the stop mechanism 36, with the bone/ribcage spreader device 10 being in the extended position, to rest upon a flat surface of the first arm 12.

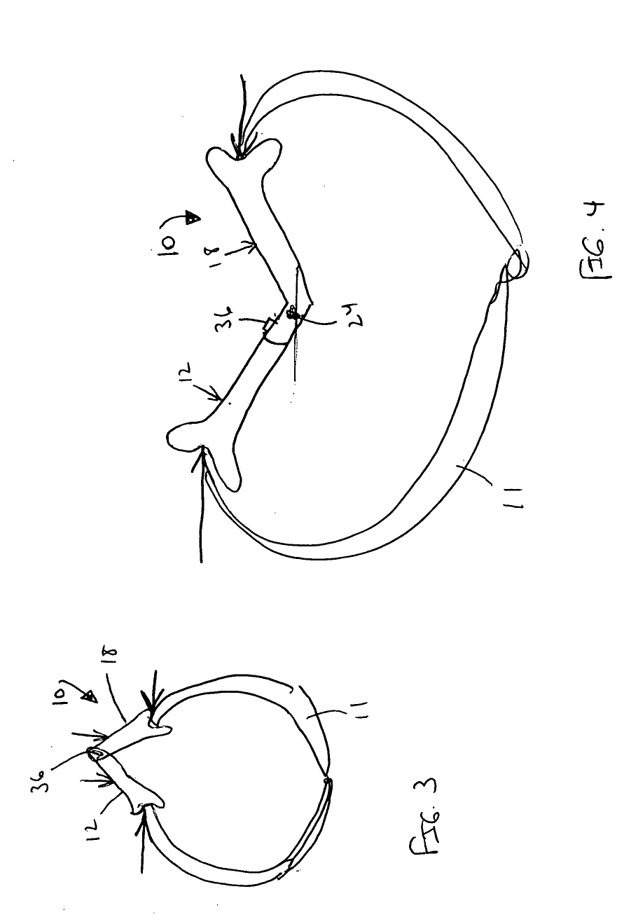

When opened, the ribcage 11 of an animal has an opposing force which acts to maintain the ribcage shut. In practice, the bone/ribcage spreader device 10 is positioned within the ribcage 11, as best illustrated in FIG. 3, with the bones of the ribcage within the recessed areas 30. The user applies a force on the bone/ribcage spreader device 10 in a direction into the ribcage 11 until the first arm 12 and the second arm 18 rotate past the pivot point 24 and the first arm 12 engages the stop mechanism 36, as best illustrated in FIG. 4. The angled portion 34 of the first arm 12 allows the bone/ribcage spreader 10 to move beyond the pivot point 24. With the force of the ribcage 11 being past or over the pivot point 24, the bone/ribcage spreader 10 releasably locks into place thereby maintaining the spread of the ribcage 11. It will be noted by the person skilled in the art that the position of the stop mechanism 36 adjacent the pivot point 24 inhibits any injury to the user from pinching or the like.

Furthermore, the bone/ribcage spreader device 10 can include a plurality of apertures 38 formed along the first arm 12 and the second arm 18 to reduce the weight of the bone/ribcage spreader device 10. It is also within the scope of the present invention to include only a single aperture 38 or elongated aperture(s) (not shown).

The bone/ribcage spreader device 10 of the present invention allows a hunter to field dress a game animal with minimal untidiness and disorder. Additionally, the bone/ribcage spreader device 10 of the present invention is easy to operate and effectively spreads the ribs for access to the inside of the game animal. Furthermore, the bone/ribcage spreader device 10 of the present invention is lightweight and easily carried by the hunter with other gear.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A bone/ribcage spreader device for spreading the bones/ribcage of a game animal, the bone/ribcage spreader device comprising:
a first arm having a first end and a second end, the second end having a first protrusion and a second protrusion surrounding a first recessed area, the first arm having a straight portion and an angled portion;
a second arm having a first end and a second end, the second end having a first protrusion and a second protrusion surrounding a second recessed area
a stop mechanism formed on the second arm, the stop mechanism contactable with the first arm; and
a pivot point at the first end of the first arm and the first end of the second arm rotatably connecting the first arm to the second arm;
wherein the bones/ribcage to be spread are positioned within the recessed portion of the first arm and the second arm such that upon rotation of the first arm and the second arm relative to each other until the stop mechanism contacts the first arm, the first arm and the second arm releasably lock thereby maintaining the bone/ribcage within each recessed portion.

2. The bone/ribcage spreader device of claim 1 and further comprising:
means for aligning the line of force between the second ends of the first arm and the second arm offset over the pivot point.

3. The bone/ribcage spreader device of claim 2 wherein the means for aligning includes a straight portion on the first arm adjacent the first end and an angled portion on the first arm adjacent the second end.

4. The bone/ribcage spreader device of claim 3 and further comprising:
a stop mechanism formed on the second arm positioned adjacent the first end of the second arm substantially between the pivot point and the first end for inhibiting the rotation of the first arm relative to the second arm when the straight portion of the first arm is substantially aligned with the second arm.

5. The bone/ribcage spreader device of claim 1 and further comprising:
means for releasably locking the first arm relative to the second arm.

6. The bone/ribcage spreader device of claim 1 and further comprising:
a plurality of apertures formed along the first arm and the second arm.

7. A mechanism for spreading the bones/ribcage of a game animal or livestock, the mechanism comprising:
first bone contacting means for contacting a first bone;
second bone contacting means for contacting a second bone, the first bone contacting means pivotally connected to the second bone contacting means; and
alignment means for aligning the line of force between the first bone and the second bone over the pivot point between the first bone contacting means and the second bone contacting means.

8. The mechanism of claim 7 wherein the first bone contacting means includes a first arm having a first end and a second end, the second end having a first protrusion and a second protrusion surrounding a first recessed area and the second bone contacting means includes a second arm having a first end and a second end, the second end having a first protrusion and a second protrusion surrounding a second recessed area.

9. The mechanism of claim 7 wherein the alignment means includes an angled portion on the first bone contacting means.

10. The mechanism of claim 7 and further comprising:
means for releasably locking the first arm relative to the second arm.

11. The mechanism of claim 7 wherein the means for releasably locking includes a stop mechanism formed on the second bone contacting means adjacent the pivot point for inhibiting the rotation of the first bone contacting means relative to the second bone contacting means.

12. The mechanism of claim 7 and further comprising:
a plurality of apertures formed along the first bone contacting means and the second bone contacting means.

13. A method for spreading the bones/ribcage of a game animal or livestock, the method comprising:
providing a first member;
providing a second member;
pivotally connecting the first member to the second member;
contacting a first bone with the first member;
contacting a second bone with the second member;
pivoting the first member in a general direction away from the second member; and
aligning the line of force between the first bone and the second bone over the pivot point between the first member and the second member.

14. The method of claim 13 wherein the first member has a first protrusion and a second protrusion surrounding a first recessed area and the second bone member has a first protrusion and a second protrusion surrounding a second recessed area, the first bone receivable within the first recessed area, the second bone receivable within the second recessed area.

15. The method of claim 13 and further comprising:
angling a portion of the first member.

16. The method of claim 13 and further comprising:
releasably locking the first member to the second member.

17. The method of claim 13 and further comprising:
forming a stop mechanism on the second member adjacent the pivot point; and
inhibiting the rotation of the first member relative to the second member.

18. The method of claim 13 and further comprising:
forming a plurality of apertures along the first member and the second member.
